(19) United States
(12) Patent Application Publication
(10) Pub. No.: US 2010/0307776 A1
(43) Pub. Date: Dec. 9, 2010

(54) Fire fighting materials by snow or sand

(76) Inventor: Keum Sook Baek, Seattle, WA (US)

Correspondence Address: Keum Sook Baek, 11045 8th Ave NE Apt 404, Seattle, WA, 98125-6130, US

(21) Appl. No.: 12/455,862

(22) Filed: Jun. 8, 2009

(51) Int. Cl. A62C 31/28

(52) U.S. Cl. 169/70; 415/121.3

(57) ABSTRACT

Recently inflammable materials become various so snow wind may be useful to extinguish things inside house or factory and sand wind may be useful for fire with oil. I think improving the way to extinguish fire may be more effective.
1. “Snow wind”: when the snow is being blown by a fan blower, it brings cooling effect being melted with absorbing much heat. When it is repeated, the snow may be piled without being melted anymore and may smother the fire area.
2. “Sand wind”: sand blown by a fan blower may smother the fire caused with oil or oil products. Especially, it's hard for people to get close to oil land fire so super size helicopter may be used to sprinkle the sand from the air covering the fire area. Even after putting off the fire, the wind from the helicopter should be continued so that the fire area can be frozen less than ignition point.

### BACKGROUND OF THE INVENTION

Inside the room people extinguish small fire with a wet blanket. What if we have a big size of fire? I saw white Christmas covered with snow which absorbs heat. I also thought that sand may help to extinguish fire in an oil field or store area. How can we fast and easily cover fire area? I thought “fan blower” may help it using the wind. Especially, there is difficulty for people to get close to fire in oil field. So I thought about dropping of sand from the air using a super size helicopter.

### SUMMARY OF THE INVENTION

Choosing sand or snow as fire fighting material, I thought about how we can fast and easily cover the fire area? Blowing the fire with the wind may be fast way to put out the fire so I “fan blower” may be useful: with “snow wind” or “sand wind.” Especially, there is difficulty for people to get close to the fire in oil field. In that case, the fire area needs to be covered by sprinkling sand from the air using a super size helicopter. And the “wind” from the “fan blower” or the “wind” from the helicopter may help extinguish fire with ventilation. This new idea indicates that there is a different way to extinguish fire depending on materials (wood or oil) causing the fire.

### BRIEF DESCRIPTION OF THE EQUIPMENT AND TERMS

(1) Fan Blower

It's a type of pipe with diameter of ±2 feet size, which may blow snow or sand with the wind.

(2) Fan Blowing Equipment

Super size fan which can blow the snow and sand enough with the wind power: Motor for that may be like auto engine with spinning control.

(3) Moving a Fan Blower

When truck like concrete truck or crane is used, we may control the fan blower freely in the fire up to 50 meters or we may use fire fighting truck with a ladder.

(4) Snow Wind

We may blow the snow to the fire with the wind using the fan blower.

(5) Sand Wind

We may blow the sand to the fire like snow above with the wind using the fan blower (especially, would be efficient for fire caused by oil. But in a fire in oil well super size helicopter may be used to sprinkle the sand from the air).

(6) Grinder

It's like a super size ice grinder. In a large and circled board many blades can be attached. When the grinder spins, this may grind snow and ice. Ex) Wood branch grinder—fan blowing system: After wood branches are grinded, the pieces can be blown automatically to the truck by a fan blower.

(7) Sandy Dirt

Sand mixed with dirt and we may get it anywhere. To separate pebbles and little stones from inside, proper net may be used then sandy dirt may be used.

(8) Auto Sand Sprinkler

Sprinkler that sand may be flown to a circle shaped spinning board automatically (much or little) by centrifugal force.

(9) Super Size Helicopter

“A super size helicopter which automatic sand sprinkler is installed” may carry sand and it may sprinkle in a big helicopter like one to carry army tanks.

(10) All the Items are Already Manufactured Commercially.

### DETAILED DESCRIPTION OF THE INVENTION

1. Snow has an element like water and it doesn't flow over. It may be melted anywhere in the fire absorbing heat. And melted cold water also may be soaked into burning materials then keep cooling function absorbing much heat. If that process happens continuously under ignition point, snow may not be melted anymore then it may cover the fire smothering the fire area. The area covered with snow may be used to prevent from fire because new fire may not move into the area easily. The fact is important because property not covered with fire is more important to protect from fire than property surrounded by blaze. When we sprinkle water in the fire, water flows away but snow goes to anywhere then gets piled. So snow is more beneficial than water. It's easy to get snow in winter but not in summer. So when we need it, we may make artificial snow from ice or dry ice. Snow wind: wind is cold one in here and it may be very effective to freeze space with fire. When “snow” is used for fan blower system, it may be grinded so that it can be blown easily inside a fan blower. To carry the snow into the truck, it may be easy if fan blowing system is used.

2. In “sand wind” sand as not a burning material may smother the fire covering the area which fire starts as being blown by the wind (with fan blower). Especially, for oil field fire sand may cover it fast and easily with the wind using fan blowers. For this use sandy dirt, which we may find anywhere, may be used properly different from sand for construction. However, when it is used, it may be strained to remove pebbles and gravels. To extinguish oil field fire auto sand sprinkler may be installed to sprinkle sand by super size helicopters from the air.

3. The role of the wind: The wind may help extinguishing with circulation effect in addition for sand or snow to be blown by fan blowers like snow wind and sand wind. Blaze burning inside building produce more carbon dioxide from materials in the fire. Much carbon dioxide produced like that repeats interaction momentarily causing bigger fire. Because sand or water may not cool the burning space, to stop the process with carbon dioxide we may use the wind from outside for ventilation and cooling. And that may help extinguish the fire. Ventilation makes heat of the flame, smoke and poisonous gas get released from outside of the building. This may help save a life and firefighters' work. There is a good thing in ventilation but only with the wind ventilation may cause fire again. So being cautious is required. Inflammable materials may not be close to the direction which the wind moves toward. I explained the importance of ventilation but in use we may need a fan blower as same size as the space inside for ventilation but that kind of fan blower may be inconvenient to use. For convenience we may need a thin fan blower. So I thought about ventilation with thickness of the fan blower related to time. If we suppose that diameter of the fan blower be ±1 to 2 feet, it may take more time for ventilation. While then to extinguish the fire, snow or sand come with the wind may cool the burning materials. When fire fighting work is with the wind for a while, better effect is expected compared to the past. In addition, in use of the wind, I think about strong wind and breeze. Strong wind from the fan blower the speed of the wind gets weaker in inverse proportion to distance. By that breadth of the wind gets larger. Strong wind may extinguish fire blowing flame but in real how to put the fan blower close enough to the flame is important. It's up to fire fighter's work. If we use concrete truck or crane as a carrier for fan blower, even in the fire up to 30 meters, we may move and control the fan blower freely. However, though the fan blower is far from the fire, it doesn't mean that breeze may not be ventilated. Only it takes more time to put off the fire. Though the weak wind may not blow the flame directly, one out of snow or sand for the time with weak wind may put off the fire helping extinguishing cooperatively.

What is claimed:

1. Fire fighting materials may be selected as “snow wind” or “sand wind” depending on flaming materials (wood products or oil etc.).

2. “Fan blowing system which includes snow grinder” to pulverize snow (fan blowing system to sprinkle sand or snow to the fire with the wind).

3. “Super size helicopter with auto sand sprinkler” (to sprinkle sandy dirt into the fire in oil field or an oil region).
